(19) United States
(12) Patent Application Publication
(10) Pub. No.: US 2020/0141030 A1
(43) Pub. Date: May 7, 2020

(54) Copolyester Material with Low Melting Point, Spinning and Weaving Functions and Method for Forming the Copolyester Material

(71) Applicant: Nan Pao Resins Chemical Co., Ltd., Tainan City (TW)

(72) Inventors: Juh-Shyong Lee, Tainan City (TW); Yuung-Ching Sheen, Tainan City (TW); Shu-Yu Ho, Tainan City (TW)

(21) Appl. No.: 16/736,171

(22) Filed: Jan. 7, 2020

Related U.S. Application Data
(63) Continuation-in-part of application No. 15/438,817, filed on Feb. 22, 2017.

(51) Int. Cl. D01F 6/84; D01D 1/02; D01G 13/00; C08G 63/183; C08G 63/85

(52) U.S. Cl. CPC D01F 6/84; D01D 1/02; D01G 13/00; D10B 2501/043; C08G 63/85; D10B 2331/04; C08G 63/183

(57) ABSTRACT

A method for forming a copolyester material includes preparing a solution of monomers, applying a polymerization to form a copolyester having a low melting point, spinning the copolyester into fiber threads to form a copolyester fiber, weaving or knitting the copolyester fiber with a common fiber to form a composite cloth having a sheet shape, cutting the composite cloth to form a determined shape, applying a hot-press process on the composite cloth under a temperature of about 120° C. to 200° C., to release tackiness of the copolyester, so that the copolyester fiber and the common fiber are bonded tightly and closely, and forming a tough film on a surface of the composite cloth by the copolyester, so that the composite cloth has functions of stiffness and abrasion resistance by the tough film.

### CROSS-REFERENCES TO RELATED APPLICATIONS

The present invention is a continuation-in-part (C.I.P.) application of the co-pending U.S. Ser. No. 15/438,817, filed on Feb. 22, 2017.

### BACKGROUND OF THE INVENTION

### 1. Field of the Invention

The present invention relates to a copolyester material and, more particularly, to a copolyester material with a low melting point, and a method for forming the copolyester material.

### 2. Description of the Related Art

Usually, the common product in the market include shoes, bags clothes and the like. A shoe upper is made of leather, suede leather or plastic material or fabric. At present, the sport shoe upper uses hot-melt fibers which are made of thermoplastic elastomer (TPU material) which presents an elastomeric feature at the normal temperature and becomes a plastic feature when being heated. Thus, the sport shoe upper is combined with a common fiber, such as PET, by stickiness of the thermoplastic elastomer. However, the TPU material contains aromatic structure which produces poisonous smokes when being burned so that the thermoplastic elastomer easily pollutes the environment and TPU is different with PET in molecular composition so that cannot be recycled and reused, thereby causing a burden to the environment. In addition, the TPU material is poor in heat resistant, has a higher price and is easily deformed and the high technique for spinning, thereby increasing the price. Further, the TPU material easily ages during a period of time, thereby decreasing the lifetime of the sport shoe upper.

With reference to the prior art reference of Livecchi (US-2016/0362820), its claim 1 disclosed a method for making jeans comprising: a) weaving a material for use as a front portion of said jeans using 100% cotton to obtain a weave construction having a yarn count, wherein the warp portion of the weave is spun with a combination of open-end spinning and ring spinning with a thread count, and the weft portion of the weave is spun with open-end spinning with a thread count; b) sulfur dyeing the resulting cotton fiber weaved material; c) singeing the sulfur dyed weaved material to obtain a uniform and smooth fabric surface; d) pre-shrinking the sulfur dyed weaved material after said singeing to form a front portion; e) weaving a material for use as a back portion of said jeans using a fabric composition which is 79% cotton, 20% filament fiber polyester, 1% spandex to obtain a weave construction having a yarn count, wherein the warp portion of the weave is spun using a combination of open-end spinning and ring spinning with a thread count, and the weft portion of the weave is made from the filament fiber polyester with a thread count; f) indigo dyeing the resulting fabric composition weaved material; g) singeing the indigo dyed weaved material to obtain a uniform and smooth fabric surface; h) pre-shrinking the indigo dyed weaved material after said singeing to form a back portion; i) cutting said front portion and said back portion and sewing said cut front portion and back portion together to produce said jeans.

With reference to the prior art reference of Jen (U.S. Pat. No. 6,620,362), it disclosed a compound bonded into the polyester molecule in the form of copolymerization, no such problems as pollution and undesired sublimation degree caused by compound moving to fiber surface therefore. Examples of the ester forming monomers of formula (1) is used in the present invention. The addition amount of the ester forming monomers of formula (1), based upon the total dicarboxylic acid components, is between 0.05.about.100 moles %. The addition manner of the above mentioned ester forming monomers of formula (1) can be accomplished by the commonly known skills used in the polyester production. For example: in one embodiment, feed the dicarboxylic acid monomers having naphthalene structure together with terephthelic acid and ethylene glycol into reactor to conduct the esterification reaction, followed by addition of commonly used antimony or germanium compounds as the polycondensation catalyst, then proceed with polycondensation to obtain the copolyester. In another embodiment, feed the ester dicarboxylane of monomers having naphthalene structure together with dimethyl terephthalate, ethylene glycol into reactor to conduct the ester exchange reaction, followed by addition of stabilizer, antimony or germanium compounds as the polycondensation catalysts, then proceed with polycondensation to obtain the copolyester. The polyester in the present invention can be produced from dicarboxylic acid/or its ester derivatives and diols. For the end use applications, additives such as deluster agents, fluorescent brighteners, antioxidants, bactericides, disodorants, antistatic agents, flame retardants, far infrared radiating ceramic powders, can be incorporated into the copolyester if required. Melting spin the copolyester chips by extruder at spinning temperature of 290.degree. C. and winding speed of 3200 meters/min, producing 125 denier/36 filament of partially oriented yarn, which is subsequently produced to flat spin of 75 denier/36 filament. Weave the flat spin to plain cloth and dye it, the light fastness measured is Class 3. Claim 1 of the Jen reference disclosed a method of manufacturing polyester fiber having improved light fastness, comprising: copolymerizing dicarboxylic acid, diol component and the ester forming monomer into a copolyester.

With reference to the prior art reference of Yoshikawa (JP 2007284846), it disclosed a fiber with a melting point of about 130° C. to 230° C.

With reference to the prior art reference of Yamaguchi (JPH 08260349), it disclosed a fabric that is subjected to a hot-press process under a temperature above 120° C.

With reference to the prior art reference of Cape (U.S. D335026), it disclosed a bag made of jean.

### BRIEF SUMMARY OF THE INVENTION

The primary objective of the present invention is to provide a copolyester material of a low melting point with great stiffness and great abrasion resistance.

In accordance with the present invention, there is provided a method for forming a copolyester material, comprising:

preparing a solution of monomers;

applying a polymerization on the solution of monomers to form a copolyester having a low melting point;

spinning the copolyester into fiber threads to form a copolyester fiber;

weaving or knitting the copolyester fiber of the copolyester with a fiber into cloth, to form a composite cloth having a sheet shape;

cutting the composite cloth to form a determined shape;

applying a hot-press process on the composite cloth under a temperature of about 120° C. to 200° C., to release tackiness of the copolyester, such that the copolyester fiber and the fiber are bonded tightly and closely; and

the tackiness released from the copolyester during the hot-press process forming a film on a surface of the composite cloth by the copolyester in the composite cloth, such that the composite cloth has stiffness and abrasion resistance by presence of the film;

wherein:

the copolyester has an intrinsic viscosity after the polymerization, and the copolyester is spun into the fiber threads and forms the copolyester fiber by the intrinsic viscosity;

the tackiness released from the copolyester during the hot-press process bonds the copolyester fiber and the fiber tightly and closely;

the copolyester fiber and the fiber are stuck and combined integrally by presence of the tackiness released from the copolyester during the hot-press process;

the copolyester has an intrinsic viscosity greater than 0.7, has an elongation smaller than one hundred and thirty (or 130), and has a tensile strength greater than two (or 2); and

the step for forming the copolyester includes:

heating the solution of monomers at a temperature of 180° C. to 230° C., and performing an esterification process under protection of nitrogen, to produce a byproduct;

collecting the byproduct produced after the esterification process;

heating the byproduct at a temperature of 200° C. to 280° C., and performing a polymerization process;

collecting residual alcohol and low polymer of the byproduct produced during the polymerization process;

releasing a vacuum system under protection of the nitrogen; and

removing and cutting the byproduct into particles, to produce a final product of the copolyester.

According to the primary advantage of the present invention, the copolyester has a low melting point and excellent tacky and adhesion under the temperature of about 120° C. to 200° C. during a hot-press process, so that the copolyester fiber of the copolyester and the common fiber are bonded tightly and closely.

According to another advantage of the present invention, the composite fiber is formed with a tough film by the feature of the copolyester to have the function of stiffness and abrasion resistance by the tough film, so that the product made by the composite fiber is not worn out easily, thereby enhancing the lifetime of the product.

According to a further advantage of the present invention, the copolyester fiber of the copolyester has a lower price, thereby decreasing the cost of fabrication.

According to a further advantage of the present invention, the product made by the composite fiber can be recycled and will not pollute the environment.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart view of a method for forming a copolyester material in accordance with the preferred embodiment of the present invention.

FIG. 2 is a flow chart view of the copolyester material for a shoe upper in accordance with the preferred embodiment of the present invention.

FIG. 3 is a perspective view of a composite fiber in accordance with the preferred embodiment of the present invention.

FIG. 4 is a perspective view of the composite fiber for a shoe upper in accordance with the preferred embodiment of the present invention.

FIG. 5 is a perspective view of the composite fiber for a shoe product in accordance with the preferred embodiment of the present invention.

FIG. 6 is a perspective view of the composite fiber for a bag product in accordance with the preferred embodiment of the present invention.

FIG. 7 is a perspective view of the composite fiber for a clothing product in accordance with the preferred embodiment of the present invention.

### DETAILED DESCRIPTION OF THE INVENTION

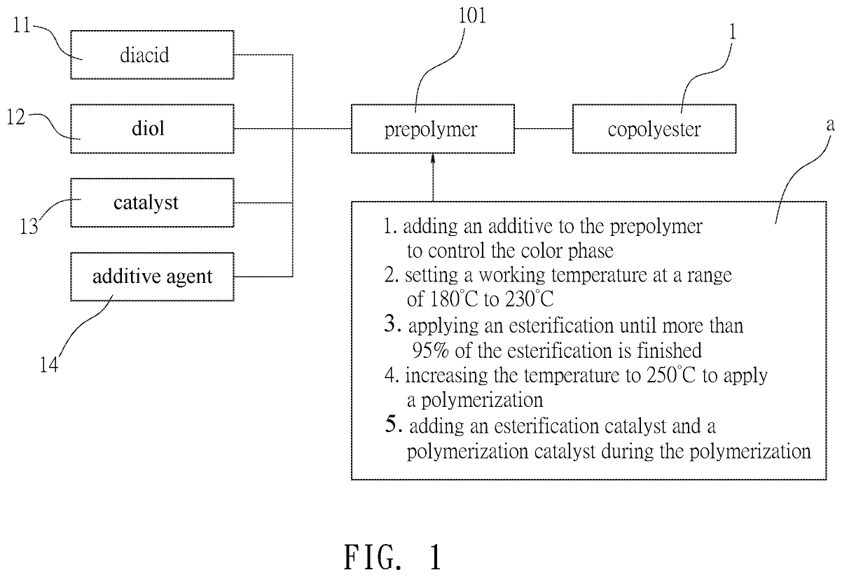

Referring to the drawings and initially to FIG. 1, a method for forming a copolyester material in accordance with the preferred embodiment of the present invention comprises preparing a solution of monomers (or prepolymer) 101 in a reaction tank, and applying a polymerization “a” on the solution of monomers 101 to form a copolyester 1 having a low melting point. The copolyester 1 is a polyester material. The solution of monomers 101 includes diacid 11, diol 12, a catalyst 13 and an additive agent 14 which are well mixed.

In the preferred embodiment of the present invention, the diacid 11 in the solution of monomers 101 includes the aromatic and the aliphatic, such as Terephthalic acid (or dimethyl ester), Adipic acid, Isophthalic acid (or dimethyl ester) or the like, and the diol 12 in the solution of monomers 101 primarily includes the C2 to C6 aliphatic, such as 1,4-butanediol, ethylene glycol, 1,6-hexanediol or the like.

The polymerization “a” includes procedures of applying an additive and controlling the temperature, and preferably includes the following steps:

1. adding an additive to the solution of monomers 101 to control the color phase;

2. setting a working temperature or an ester reaction temperature at a range of 180° C. to 230° C.;

3. applying an esterification to the solution of monomers 101 until more than 95% of the esterification is finished;

4. increasing the temperature to 250° C. to apply a polymerization process to the solution of monomers 101; and

5. adding a esterification catalyst and a polymerization catalyst to the solution of monomers 101 at the beginning.

In the preferred embodiment of the present invention, the additive is an anti-oxidant. In the esterification, the diacid 11 and the diol 12 are reacted to perform the esterification reaction. When the percent conversion of the diacid 11 and the diol 12 is more than 95%, the esterification is finished. Thus, more than 95% of the solution of monomers 101 is esterified.

In the polymerization process, the degree of vacuum in the reaction tank is gradually adjusted in a stepwise manner to a value under 10 torr. The polymerization process is stopped when a required viscosity is reached, thereby forming the copolyester 1 after the polymerization process. The required viscosity is an intrinsic viscosity of the copolyester 1 to judge if the polymerization reaches the requirement.

In practice, the copolyester 1 is made as follows. The solution of monomers 101 includes Terephthalic acid of 300-500 g, Isophthalic acid of 130-300 g, Adipic acid of 100-200 g, ethylene glycol of 70-100 g, butanediol of 550-700 g, and Tetrabutyl titanate of 0.1-0.5 g. The solution of monomers 101 is placed in a reaction kettle (or reactor) of 2 L. Then, the solution of monomers 101 is heated at a temperature of 180° C. to 230° C., to perform an esterification process under protection of nitrogen, to produce a byproduct. The byproduct produced after the esterification process is collected. Then, the byproduct is heated at a temperature of 200° C. to 280° C., to perform a polymerization process. The residual alcohol and low polymer (or oligomer) of the byproduct produced during the polymerization process are collected. Then, a vacuum system is released under protection of the nitrogen. Then, the byproduct is removed and cut into particles, to produce a final product of the copolyester 1.

The copolyester 1 is an innovative environmentally friendly material and has a melting point of about 100° C. to 180° C.

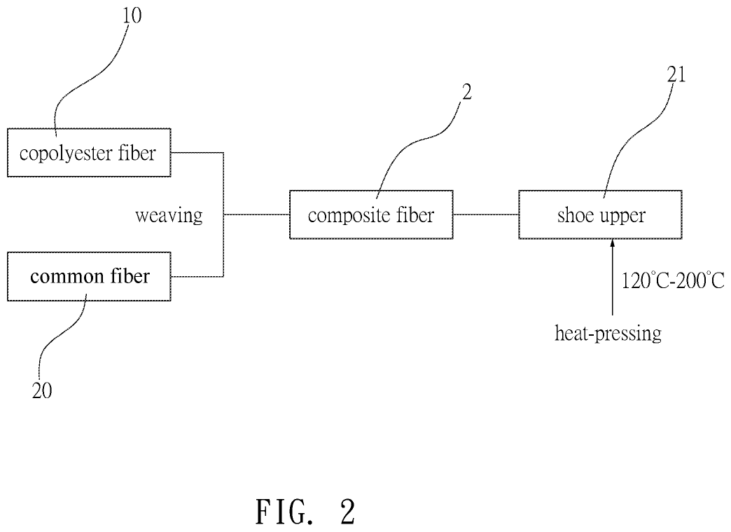

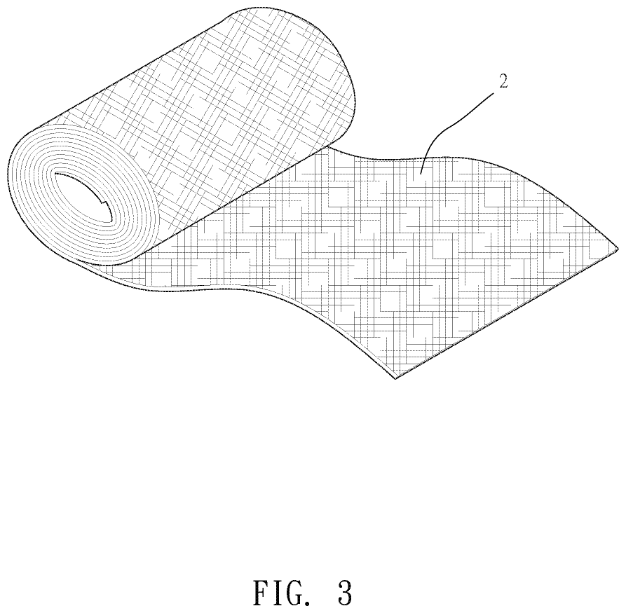

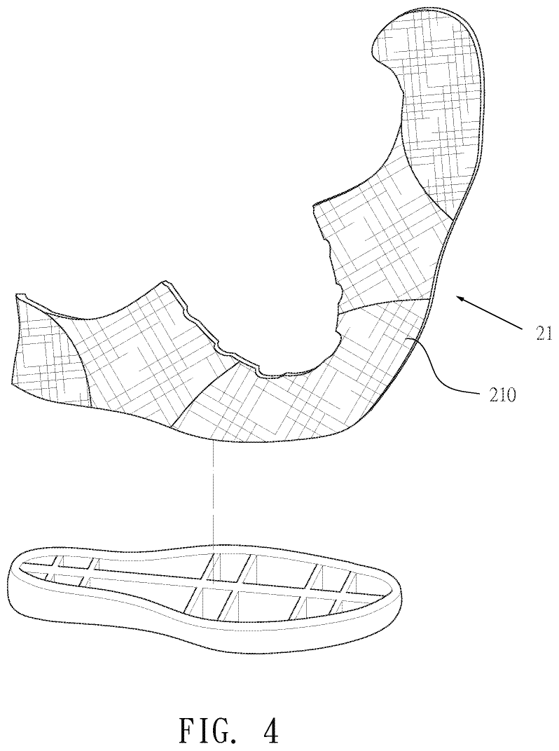

Referring to FIGS. 2-4 with reference to FIG. 1, the copolyester 1 is spun into elongate fiber threads to form a copolyester fiber 10. The copolyester fiber 10 of the copolyester 1 and a common fiber 20 are woven or knitted into cloth, so that the copolyester fiber 10 and the common fiber 20 are combined to form a composite cloth (or composite fiber) 2 having a sheet shape. The composite cloth 2 is an environmentally friendly plastic material. The common fiber 20 includes PET, Nylon or nature materials. The composite cloth 2 is cut to form a determined shape, such as a shoe upper 21. Then, a hot-press process is applied on the shoe upper 21 (or the composite cloth 2) under the temperature of about 120° C. to 200° C., to release the tackiness of the copolyester 1, so that the copolyester fiber 10 and the common fiber 20 are bonded tightly and closely. In such a manner, the shoe upper 21 (or the composite cloth 2) has a surface formed with a tough film 210 by the feature of the copolyester 1, so that the shoe upper 21 (or the composite cloth 2) has the function of stiffness and abrasion resistance by the tough film 210, thereby enhancing the lifetime of the shoe upper 21. Thus, the composite cloth 2 functions as a semi-product which is cut properly according to the practical requirement, so as to form a composite cloth product which is a combination of cloth material and plastic material.

In the preferred embodiment of the present invention, the copolyester 1 has a low melting point and has a better abrasion resistance. Preferably, the copolyester 1 has an intrinsic viscosity (IV) greater than 0.7 (IV>0.7), has an elongation (%) smaller than 130, has a tensile strength (cN/dtex) greater than 2, and has a molecular weight greater than 30,000, such that the copolyester 1 is spun into the fiber threads to form the copolyester fiber 10 easily.

In experimentation, the copolyester fiber 10 and the common fiber 20 are combined by a proportion of 1:3 to form the composite cloth 2. The composite cloth 2 and conventional cloth are tested under a condition of 1LB/G12. The following table shows the results of test.

| | | Abrasion | Abrasion |
|---|---|---|---|
| | | resistance | resistance |
| | | of the | of the |
| Sample | Testing condition | invention | conventional product |
| Cloth 1 | Abrasion load 1LB/G12 | 368 | 63 |
| Cloth 2 | Abrasion load 1LB/G12 | 293 | 58 |
| Cloth 3 | Abrasion load 1LB/G12 | 344 | 87 |

It is shown that, the abrasion (or wear) resistance (368, 293, and 344) of the composite cloth 2 of the present invention is much greater than that (63, 58, and 87) of the conventional cloth.

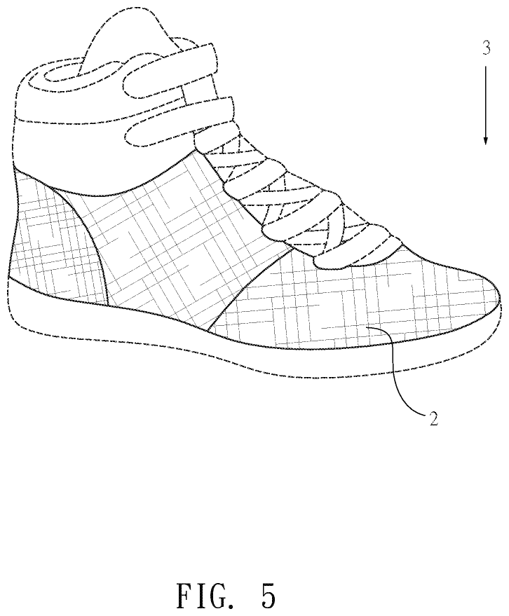

Referring to FIG. 5, the composite cloth 2 is available for a shoe product 3.

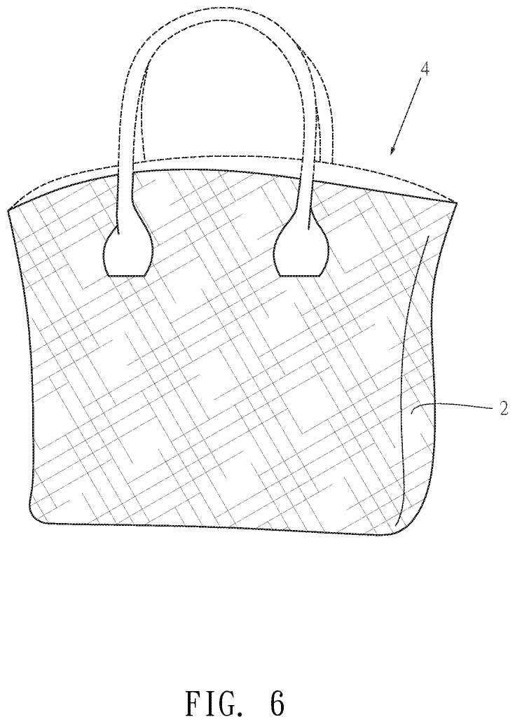

Referring to FIG. 6, the composite cloth 2 is available for a bag product 4.

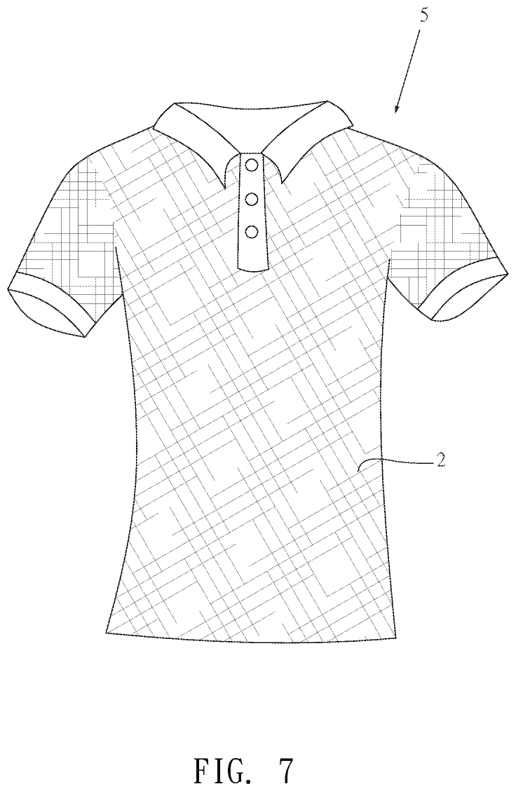

Referring to FIG. 7, the composite cloth 2 is available for a clothing product 5.

Accordingly, the copolyester 1 has a low melting point and releases tackiness under the temperature of about 120° C. to 200° C. during a hot-press process, so that the copolyester fiber 10 of the copolyester 1 and the common fiber 20 are bonded tightly and closely. In addition, the composite cloth 2 is formed with a tough film 210 by the feature of the copolyester 1 to have the function of stiffness and abrasion resistance by the tough film 210, so that the product made by the composite cloth 2 is not worn out easily, thereby enhancing the lifetime of the product. Further, the copolyester fiber 10 of the copolyester 1 has a lower price, thereby decreasing the cost of fabrication. Further, the product made by the composite cloth 2 can be recycled and will not pollute the environment.

In the present invention, the copolyester 1 with a low melting point and with a tackiness function is spun into fiber threads to form a copolyester fiber 10, and the copolyester fiber 10 of the copolyester 1 is then woven with a fiber into cloth, to form the composite cloth 2 having a sheet shape. It is noted that, the copolyester 1 has a intrinsic viscosity after the polymerization, such that the copolyester 1 is spun into the fiber threads by the intrinsic viscosity. In general, the intrinsic viscosity (IV) is greater than 0.7 (IV>0.7) such that the copolyester 1 is drawn into the fiber threads smoothly and steadily. If the intrinsic viscosity (IV) is too small, the fiber threads are easily broken. Thus, the material of the monomers (including diacid, diol, a catalyst and an additive agent) is very important. In such a manner, the copolyester fiber 10 has a strong tackiness, and is fully fused by heat after the copolyester fiber 10 is woven, such that the copolyester fiber 10 of the copolyester 1 is attached to the fiber (or PET) 20 exactly.

In the present invention, the copolyester 1 has a great intrinsic viscosity, such that 100% of the copolyester 1 is drawn into the fiber threads. In addition, the copolyester 1 has a low melting point of about 100° C. to 180° C., such that after the copolyester fiber 10 is woven, the copolyester 1 is melted completely when being heated, and is attached to the fiber (or PET) closely.

On the other hand, the hot-press process is applied on the composite cloth 2 after the copolyester fiber 10 of the copolyester 1 and the fiber (or PET) 20 are woven to form the composite cloth 2, to release tackiness of the copolyester 1, such that 100% of the copolyester fiber 10 of the copolyester 1 is melted to form a transparent glue which is hot stuck onto the fiber (or PET) 20, without having to provide an adhesive additionally. At this time, the tackiness released from the copolyester 1 during the hot-press process forms a film on the surface of the composite cloth 2 by the copolyester 1 in the composite cloth 2, so that the composite cloth 2 has greater stiffness and great abrasion resistance by presence of the film.

In practice, combination of the copolyester fiber 10 of the copolyester 1 and the fiber (or PET) 20 is described as follows. The copolyester 1 having a low melting point is initially spun into elongate fiber threads. Then, the elongate fiber threads and the fiber (or PET) 20 are interwoven to form the composite cloth 2 having a sheet shape. At this time, the elongate fiber threads and the fiber (or PET) 20 are combined integrally such that the composite cloth 2 has an integral structure. Then, the copolyester fiber 10 of the copolyester 1 is melted after the hot-press process to form a transparent glue which is hot stuck onto the fiber (or PET) 20, such that the copolyester fiber 10 of the copolyester 1 and the fiber (or PET) 20 are adhered together and engage each other closely, without producing friction, so as to enhance the stiffness and the abrasion resistance of the composite cloth 2. Thus, the shoe upper 21 is wear resistant and has a longer lifetime when the composite cloth 2 is used for the shoe upper 21.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for forming a copolyester material, comprising:
preparing a solution of monomers;
applying a polymerization on the solution of monomers to form a copolyester having a low melting point;
spinning the copolyester into fiber threads to form a copolyester fiber;
weaving or knitting the copolyester fiber of the copolyester with a fiber into cloth, to form a composite cloth having a sheet shape;
cutting the composite cloth to form a determined shape;
applying a hot-press process on the composite cloth under a temperature of about 120° C. to 200° C., to release tackiness of the copolyester, such that the copolyester fiber and the fiber are bonded tightly and closely; and
the tackiness released from the copolyester during the hot-press process forming a film on a surface of the composite cloth by the copolyester in the composite cloth, such that the composite cloth has stiffness and abrasion resistance by presence of the film;
wherein:
the copolyester has an intrinsic viscosity after the polymerization, and the copolyester is spun into the fiber threads and forms the copolyester fiber by the intrinsic viscosity;
the tackiness released from the copolyester during the hot-press process bonds the copolyester fiber and the fiber tightly and closely;
the copolyester fiber and the fiber are stuck and combined integrally by presence of the tackiness released from the copolyester during the hot-press process;
the copolyester has an intrinsic viscosity greater than 0.7, has an elongation smaller than one hundred and thirty (or 130), and has a tensile strength greater than two (or 2); and
the step for forming the copolyester includes:
heating the solution of monomers at a temperature of 180° C. to 230° C., and performing an esterification process under protection of nitrogen, to produce a byproduct;
collecting the byproduct produced after the esterification process;
heating the byproduct at a temperature of 200° C. to 280° C., and performing a polymerization process;
collecting residual alcohol and low polymer of the byproduct produced during the polymerization process;
releasing a vacuum system under protection of the nitrogen; and
removing and cutting the byproduct into particles, to produce a final product of the copolyester.

2. The method of claim 1, wherein the copolyester has a melting point of about 100° C. to 180° C.

3. The method of claim 1, wherein the composite cloth is made into a shoe upper or a bag.

4. The method of claim 1, wherein the solution of monomers includes Terephthalic acid of 300-500 g, Isophthalic acid of 130-300 g, Adipic acid of 100-200 g, ethylene glycol of 70-100 g, butanediol of 550-700 g, and Tetrabutyl titanate of 0.1-0.5 g.
